(19) United States
(12) Patent Application Publication
(10) Pub. No.: US 2025/0283552 A1
(43) Pub. Date: Sep. 11, 2025

(54) METHOD FOR DETERMINING THE SWITCHING POSITION OF A DIRECTLY CONTROLLED HYDRAULIC VALVE, METHOD FOR CONTROLLING A DIRECTLY CONTROLLED HYDRAULIC VALVE, HYDRAULIC VALVE AND HYDRAULIC SYSTEM

(71) Applicant: HAWE Hydraulik SE, Aschheim (DE)

(72) Inventors: Markus Neumair, Aschheim (DE); Benjamin Hasner, Aschheim (DE)

(73) Assignee: HAWE Hydraulik SE, Aschheim (DE)

(21) Appl. No.: 19/070,975

(22) Filed: Mar. 5, 2025

(30) Foreign Application Priority Data
Mar. 8, 2024 (DE) 10 2024 202 200.4

(51) Int. Cl. F16K 31/06; H01F 7/18

(52) U.S. Cl. CPC F16K 31/0675; F16K 31/0606; H01F 7/1844; H01F 2007/185

(57) ABSTRACT

A method for determining the switching position of a directly controlled hydraulic valve is provided. The hydraulic valve has a valve element and a solenoid with a coil and an armature. A control unit associated to the hydraulic valve impresses a coil current in the coil S of the solenoid, which is composed of an actuating current and a measuring current profile superimposed on the actuating current. The impressed coil current is recorded as a current profile, on the basis of which a compensation characteristic value and a position characteristic value are determined, from which the switching position of the hydraulic valve is calculated.

### CROSS REFERENCE TO RELATED APPLICATION

This application claims the priority benefit from German Patent Application No. 10 2024 202 200.4, filed on Mar. 8, 2024, the entire contents of which is incorporated herein by reference in its entirety.

### FIELD

The present disclosure relates to a method for determining the switching position of a directly controlled hydraulic valve, a method for controlling a directly controlled hydraulic valve as well as a hydraulic valve and a hydraulic system.

### BACKGROUND

In the case of directly controlled, e.g., electromagnetically actuated, hydraulic valves, a valve element of the hydraulic valve is coupled to an armature of a solenoid of the hydraulic valve for joint movement between different switching positions of the hydraulic valve. This coupling can, for example, consist of a fixed connection between the armature and the valve element or of a valve tappet that is firmly connected to the armature and rests against the valve element. By energizing a coil of the solenoid, the armature and the valve element are moved between the different switching positions against the force of a return element, usually a return spring. The movement of the valve element between the different switching positions blocks or releases at least one connection of the hydraulic valve. As a result, a volume flow of hydraulic fluid flows through the hydraulic valve depending on the switching position of the valve element. The valve element can be a valve piston or a valve seat element.

The variable switching position of the valve element results in a variable opening cross-section of the hydraulic valve, which in turn provides a variable volume flow via the hydraulic valve. For this purpose, a controlled actuating current is impressed into the coil of the solenoid, on which the switching position of the hydraulic valve depends. However, the actual switching position of the hydraulic valve is also dependent on other boundary conditions (disturbance variables), such as friction- and/or temperature-dependent hysteresis effects, the system pressure of a higher-level hydraulic system and the ambient or system temperature, which can have an influence on the properties of the solenoid, for example.

In order to be able to adjust the volume flow provided by such a directly controlled hydraulic valve as precisely and reproducibly as possible, it is therefore desirable to compensate for such disturbance variables as far as possible. Such compensation is usually achieved by providing a dedicated position sensor that measures the actual current switching position of the hydraulic valve, e.g., the switching position of the valve element and/or the armature. Based on the measured switching position, a downstream position control can in turn be carried out in order to control the volume flow provided via the hydraulic valve.

However, such dedicated position sensors for detecting the switching position of a hydraulic valve are usually complex components, the use of which drives up costs, increases the required installation space and also increases the complexity and therefore the susceptibility to faults of the overall system.

DE 10 2022 202 224 A1 also discloses methods for determining the switching position of a directly controlled hydraulic valve with two solenoids for actuating the valve element on the respective non-actuated solenoid.

### SUMMARY

A method for determining the switching position of a directly controlled hydraulic valve is provided. In some embodiments, the hydraulic valve has a valve element and a solenoid with a coil and an armature. The armature may be coupled to the valve element for joint movement between different switching positions. A control unit associated with the hydraulic valve impresses a coil current in the coil S of the solenoid. The coil current is composed of an actuating current and a measuring current profile superimposed on the actuating current. The impressed coil current is recorded as a current profile. A compensation characteristic value and a position characteristic value are determined based on the recorded current profile. The switching position of the hydraulic valve is calculated on the basis of the compensation characteristic value and the position characteristic value.

A method for controlling a directly controlled hydraulic valve is also provided. The switching position of the hydraulic valve can be controlled based on the calculated switching position.

The measuring current profile may have a maximum measuring amplitude that depends on the current actuating current.

The measuring current profile may have a maximum measuring amplitude that corresponds to a dither amplitude.

The compensation characteristic value of the hydraulic valve may be a temperature-dependent compensation characteristic value of the solenoid.

The position characteristic value of the hydraulic valve may be a temperature and inductance-dependent position characteristic value of the solenoid.

A hydraulic system is also provided with a hydraulic valve according to the embodiment provided herein.

In some embodiment, the control unit may be integrated into the hydraulic valve.

### BRIEF DESCRIPTION

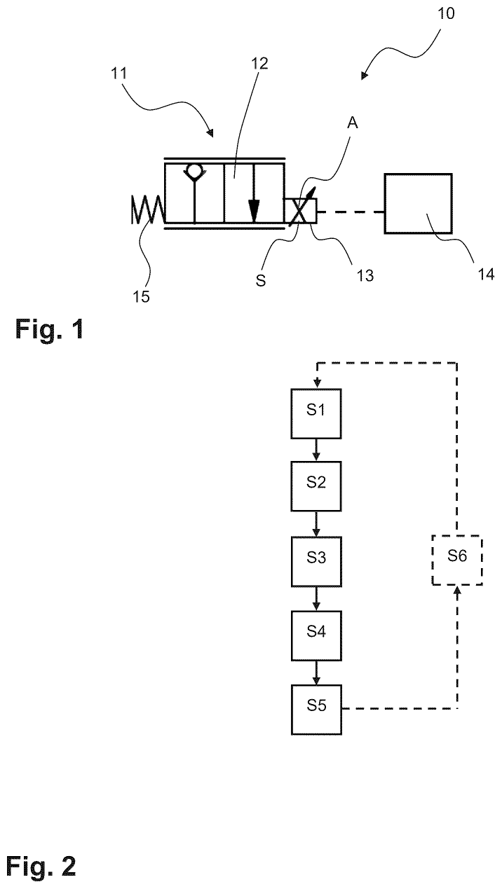

FIG. 1 depicts a hydraulic system with a directly controlled hydraulic valve according to an exemplary embodiment of the present disclosure;

FIG. 2 depicts a flow diagram of a method according to the disclosure;

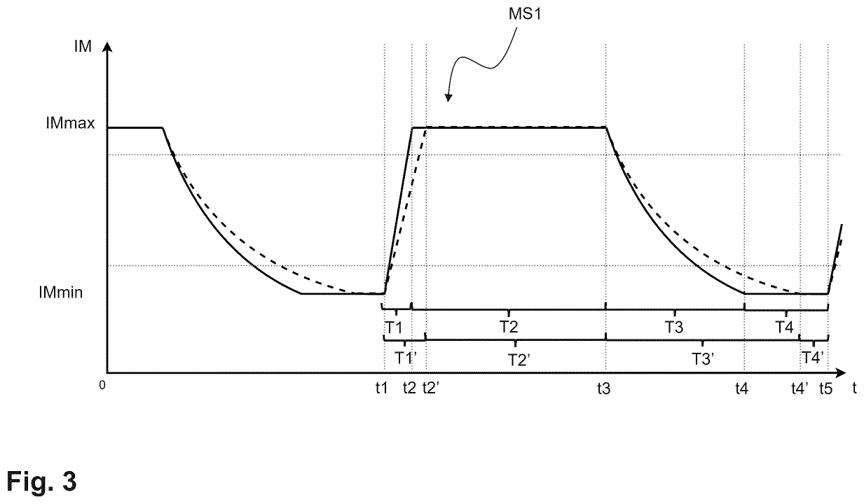

FIG. 3 depicts a diagram illustrating a first measuring current profile; and

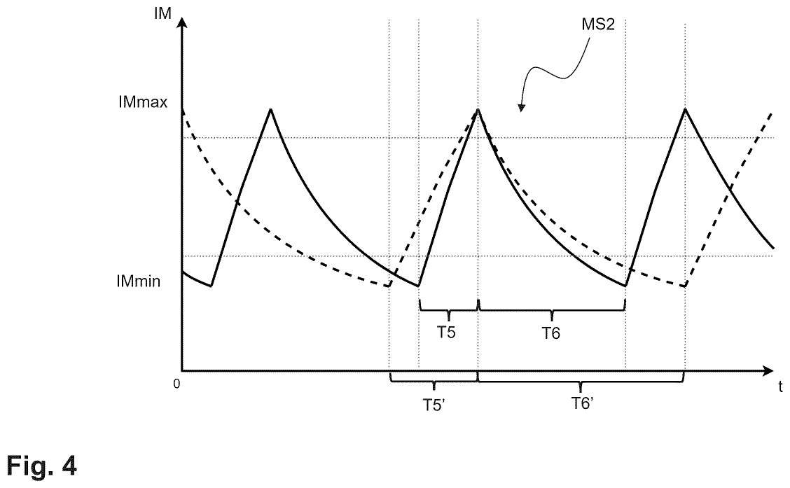

FIG. 4 depicts a diagram illustrating a second measuring current profile.

### DETAILED DESCRIPTION

It is an object of the present disclosure to provide an improved possibility for controlling the volume flow via a directly controlled hydraulic valve, which can also be applied to directly controlled hydraulic valves with a single solenoid for actuating the valve element (e.g., instead of a plurality of solenoids for actuating the valve element).

The problem is first solved by a method for determining the switching position of a directly controlled hydraulic valve according to the embodiment of the present disclosure. The hydraulic valve comprises a valve element and a solenoid with an armature and a coil. The armature is coupled to the valve element for joint movement between different switching positions. The method is carried out by a control unit associated with the hydraulic valve and comprises the following steps:
impressing a coil current in the coil of the solenoid, wherein the coil current is composed of an actuating current and a measuring current profile superimposed on the actuating current;
recording of the impressed coil current over time as a current profile;
determining a compensation characteristic value of the hydraulic valve based on the recorded current profile;
determining a position characteristic value of the hydraulic valve based on the recorded current profile; and
calculating the switching position of the hydraulic valve based on the compensation characteristic value and the position characteristic value.

According to the disclosure, the solenoid of the hydraulic valve is therefore not only subjected to the actuating current to switch the hydraulic valve. Rather, the measuring current profile is superimposed on the actuating current and the coil current impressed in the coil of the solenoid, which represents the combination of the actuating current and the measuring current profile, is measured. In other words, the actuating current and the measuring current profile are simultaneously impressed in the coil of the solenoid and recorded together as a current profile. The compensation characteristic value and the position characteristic value are determined from the recorded current profile in order to calculate the actual current switching position of the hydraulic valve. By superimposing the measured current profile on the actuating current and detecting the impressed coil current, the switching position of the hydraulic valve can also be determined at the actuated solenoid of the hydraulic valve. This makes it possible, even in the case of directly controlled hydraulic valves with a single solenoid for actuating the valve element, to carry out precise position or volume flow control without having to use a dedicated position sensor in the form of a separate component. The method according to the disclosure can save both costs and installation space and increase the reliability of the system in which the hydraulic valve is used, as fewer system components are used overall.

The term “determining” used here includes one or more process steps such as control, measurement and/or calculation in order to determine the corresponding value. System-defined values can also be used for determination.

In particular, the control unit comprises a current sensor for measuring the current in the coil of the solenoid and a solenoid control unit, which controls the actuation of the solenoid in a generally known manner by means of a supply voltage. The control unit is in particular an electronic control unit.

In some aspects, the measuring current profile has a maximum measuring amplitude that depends on the current actuating current. In particular, the measuring current profile has a variable measuring amplitude that depends on an actuation amplitude of the current actuation current. In particular, the current actuating current is detected separately and the maximum measurement amplitude is set depending on the detected current actuating current. It should be noted that temporary current peaks above the set maximum measuring amplitude can also occur, but due to their short duration and the inertia of the overall system, they do not lead to a significant movement of the valve element for the volume flow flowing via the hydraulic valve. For hydraulic valves where there is a particularly large difference in amplitude between the minimum and maximum actuating current, the variable maximum measuring amplitude can be used to ensure that the amplitude of the measuring current profile is not lost in the actuating amplitude of the actuating current.

In some aspects, the measuring current profile has a maximum measuring amplitude that corresponds to a dither amplitude. In particular, the dither amplitude is up to 20% of an actuating amplitude of the current actuating current of the solenoid. The use of dither signals is known, for example, from the field of continuous hydraulic valves. Here, a rectangular alternating current signal (dither frequency) with a low amplitude (dither amplitude) is superimposed on a direct actuating current in order to cause the valve element of the continuous hydraulic valve to vibrate, thereby avoiding static friction and reducing hysteresis effects. In abstract terms, the dither amplitude of a hydraulic valve therefore corresponds to an amplitude that leads to a slight movement of the valve element, which in particular is above a minimum actuation current of the hydraulic valve. The fact that the maximum measurement amplitude “corresponds to a dither amplitude” should also be understood to mean that temporary current peaks above the dither amplitude can also occur, but due to their short duration and the inertia of the overall system, they do not lead to a significant movement of the valve element for the volume flow flowing via the hydraulic valve. In particular, the measuring current profile can therefore have a maximum measuring amplitude that is above a minimum actuation current of the hydraulic valve and even leads to small movements of the valve element, which, however, have no significant influence on the switching position of the hydraulic valve. It is also conceivable that the measuring current profile has a measuring frequency that corresponds to a dither frequency.

In some aspects, the compensation characteristic value of the hydraulic valve is a temperature-dependent compensation characteristic value of the solenoid. In particular, the temperature-dependent compensation characteristic value of the solenoid is the electrical resistance, in particular the copper resistance, of the coil of the solenoid, which is determined during a holding interval of the measuring current profile in which the measurement amplitude is kept constant. Alternatively, the temperature-dependent compensation characteristic value of the solenoid is a current rise rate in the recorded current profile, which is determined during a rise interval of the measuring current profile in which the measuring amplitude increases. This allows a temperature dependency to be taken into account and compensated for when determining the switching position of the hydraulic valve.

In some aspects, the position characteristic value of the hydraulic valve is a temperature and inductance-dependent position characteristic value of the solenoid. In particular, the temperature and inductance-dependent position characteristic value of the solenoid is a current decrease rate in the recorded current profile, which is determined during a decay interval of the measuring current profile in which the measurement amplitude decreases. The temperature dependence can be compensated for by offsetting against the compensation characteristic value. The inductance of a solenoid depends in particular on the position of the armature within the coil, so that the position of the armature in the coil and thus the switching position of the hydraulic valve can be calculated via the inductance dependence of the position characteristic value.

Furthermore, the solution to the problem is achieved by a method for controlling a directly controlled hydraulic valve. The hydraulic valve comprises a valve element and a solenoid with an armature and a coil. The armature is coupled to the valve element for joint movement between different switching positions. The method is carried out by a control unit associated with the hydraulic valve and comprises the following steps:
determining the switching position of the hydraulic valve by the method described above for determining a switching position of a hydraulic valve; and
controlling the switching position of the hydraulic valve based on the determined switching position.

By controlling the switching position of the hydraulic valve, the flow rate flowing via the hydraulic valve can be controlled. Thus, according to the disclosure, a position or volume flow control for the hydraulic valve is implemented, for which the use of a separate position sensor in the form of an independent component is no longer necessary and which can also be used for directly controlled hydraulic valves with a single solenoid for actuating the valve element.

Furthermore, the solution to the problem is achieved by a hydraulic valve with a valve element and a solenoid with an armature and a coil. The armature is coupled to the valve element for joint movement between different switching positions. The hydraulic valve further comprises an integrated control unit which is configured to carry out one of the methods described above for determining a switching position of a directly controlled hydraulic valve and for controlling a directly controlled hydraulic valve.

In addition, a hydraulic system with a hydraulic valve solves the problem. The hydraulic valve comprises a valve element and a solenoid with an armature and a coil. The armature is coupled to the valve element for joint movement between different switching positions, wherein the hydraulic system further comprises a control unit associated with the hydraulic valve, which is configured to perform one of the methods described above for determining a switching position of a directly controlled hydraulic valve and for controlling a directly controlled hydraulic valve. Preferably, the control unit is integrated into the hydraulic valve.

FIG. 1 shows a hydraulic system 10 of an exemplary embodiment of the present disclosure with a directly controlled hydraulic valve 11 and a control unit 14 (e.g., an electronic control unit) associated with the hydraulic valve 11. The hydraulic valve 11 comprises a valve element 12, a solenoid 13 and a return element 15, which is shown here schematically as a return spring. The hydraulic valve 11 is a directly controlled, proportional 2/2-way seat valve. In the present embodiment, the valve element 12 is therefore a valve closing element which, in the closed switching position of the hydraulic valve 11, rests against a seat in the housing of the hydraulic valve 11 and blocks the two connections of the hydraulic valve 11 against each other so that no hydraulic fluid can flow via the hydraulic valve 11.

The solenoid 13 comprises a coil S and an armature A. By energizing the coil S of the solenoid 13 with an actuating current, the armature A of the solenoid 13, which is coupled to the valve element 12 for movement between the different switching positions of the hydraulic valve 11, moves with the valve element 12 against the return force of the return element 15. Depending on the actuating amplitude of the actuating current, the hydraulic valve 11 can be moved between its closed switching position and its fully open switching position into different switching positions and a variable volume flow of hydraulic fluid can be provided via the hydraulic valve 11.

The coil S is energized by the control unit 14 assigned to the hydraulic valve 11, which is shown here as being separate from the hydraulic valve 11. The signal connection between the solenoid 13 of the hydraulic valve 11 and the control unit 14 is shown schematically as a dashed line in FIG. 1. However, it is also conceivable that the control unit 14 is integrated into the hydraulic valve 11, for example in a housing of the solenoid 13, and is in turn connected to a higher-level control unit of the hydraulic system 10 in terms of signal technology.

The control unit 14 thus actuates the hydraulic valve 11 via its solenoid 13. In addition, the control unit 14 is configured to carry out the method according to the disclosure for determining the switching position of the hydraulic valve 11. For this purpose, the control unit 14 superimposes a measuring current profile on the actuating current for switching the hydraulic valve 11 and records the coil current impressed in the coil S over the time t as a current profile, as explained in detail below.

FIG. 3 shows an exemplary first measuring current profile MS1 over time t. In the first measuring current profile MS1 in FIG. 3, the measurement amplitude IM is increased during a rise interval T1, T1′ (time t1 to t2, t2′) up to a defined maximum measurement amplitude IMmax, held at the maximum measurement amplitude IMmax during a first hold interval T2, T2′ (time t2, t2′ to t3) and then during a decay interval T3, T3′ (time t3 to t4, t4′) the voltage for generating the coil current is removed until the measurement amplitude IM has reached a defined minimum measurement amplitude IMmin and finally during a second hold interval T4, T4′ (time t4, t4′ to t5) the measurement amplitude IM is held at the minimum measurement amplitude IMmin. During the decay interval T3, T3′, no voltage is applied to the coil. As a result, the coil current drops from the defined maximum measurement amplitude IMmax to the defined minimum measurement amplitude IMmin during the free running decay interval T3, T3′ and is held there until time t5. In this case, the time interval t1 to t5 corresponds to a dither period of the hydraulic valve 11.

The inductance of the coil S varies depending on how far the armature A is inside the coil S, e.g., the current position of the valve element 12, which is why the length of the decay interval T3, T3′ of the measurement amplitude IM varies during free running. FIG. 3 shows an example of a first decay interval T3 and a second decay interval T3′, each of which represents the time for the measurement amplitude IM to fall from its defined maximum value IMmax to the defined minimum value IMmin. The longer second decay interval T3′ (dashed curve in FIG. 3) corresponds to a case in which the armature A is located further inside the coil S, e.g., the inductance of the coil S is higher than in the case of the shorter decay interval T3 (solid curve in FIG. 3). The switching position of the hydraulic valve 11 can therefore be derived from the length of the decay interval T3, T3′. FIG. 3 also shows that the length of the rise interval T1, T1′ also depends on the position of the armature A within the coil S.

In the present case, a dither signal is used for the first measuring current profile MS1 according to FIG. 3 in order to measure the position of the armature A within the coil S. Accordingly, the dither period from t1 to t5 is selected so that the decay interval T3, T3′, during which the measurement amplitude IM in free running drops from the maximum measurement amplitude IMmax to the minimum measurement amplitude IMmin, is shorter than half the dither period from time t3 to time t5 for the switching positions of the hydraulic valve 11 (positions of the armature A within the coil S). This ensures that the switching position of the hydraulic valve 11 can be reliably determined by using the dither signal.

FIG. 4 shows an alternative second measuring current profile MS2, which also alternates between a defined maximum measuring amplitude IMmax and a defined minimum measuring amplitude IMmin. In the second measuring current profile MS2 in FIG. 4, however, the measuring amplitude IM is not held at its maximum value IMmax, but is switched to free running directly when the maximum measuring amplitude IMmax is reached. In addition, the measuring amplitude IM is not maintained when the minimum measuring amplitude IMmin is reached, but is directly increased again up to the maximum measuring amplitude IMmax. In the second measuring current profile MS2, the rise time of the measuring amplitude IM during the rise interval T5, T5′ is also one of the parameters to be recorded. This rise time depends on the position of the armature A in the coil S, resulting in a shorter first rise interval T5 (solid curve in FIG. 4) and a longer second rise interval T5′ (dashed curve in FIG. 4) for the two curves shown as examples in FIG. 4. Analogous to FIG. 4, there is also a shorter first decay interval T6 and a longer second decay interval T6′. The length of the rise interval T5 and the length of the decay interval T6 of the measurement amplitude IM in the second measuring current profile MS2 are, as is generally known, a measure of the position of the armature A within the coil S and the switching position of the hydraulic valve 11.

The maximum measuring amplitude IMmax and the minimum measuring amplitude IMmin are variable both for the first measuring current profile MS1 and for the second measuring current profile MS2 and are set by the control unit 14 as a function of the recorded current actuating current or its actuating amplitude. In particular, in the present embodiment, the control unit 14 sets the maximum measurement amplitude IMmax so that it corresponds to a dither amplitude of the hydraulic valve 11. As a result, the cyclical repetition of the measuring current profiles MS1 and MS2 shown in FIGS. 3 and 4 and the resulting alternation between the maximum measuring amplitude IMmax and the minimum measuring amplitude IMmin keep the valve element 12 of the hydraulic valve 11 in slight oscillating movements. These oscillating movements prevent static friction of the valve element 12 and thus reduce hysteresis effects when the hydraulic valve 11 is switched.

With reference to FIGS. 2 to 4, the method according to the disclosure for determining a switching position of the hydraulic valve 11, which is carried out by the control unit 14, is described below.

In step S1, a coil current is impressed in the coil S of the solenoid 13, which is composed of an actuating current and a measuring current profile MS1, MS2 superimposed on the actuating current. In the present case, the actuating current is a controlled direct current for switching the hydraulic valve 11 to a switching position dependent on the actuating current. As described above, an exemplary first measuring current profile MS1 is shown in FIG. 3 and an exemplary second measuring current profile MS2 is shown in FIG. 4. The coil current impressed in the coil S in step SI is thus in the present case in a first alternative the sum of the actuating current for switching the hydraulic valve 11 and the first measuring current profile MS1 or in a second alternative the sum of the actuating current for switching the hydraulic valve 11 and the second measuring current profile MS2.

In step S2, the impressed coil current is recorded over time as a current profile by the control unit 14. Step S2 takes place in parallel with the impressing of the coil current from step S1.

In step S3, a compensation characteristic value of the hydraulic valve 11 is determined by the control unit 14 on the basis of the recorded current profile. In this case, the compensation characteristic value is a temperature-dependent compensation characteristic value. When using the first measuring current profile MS1, the temperature-dependent compensation characteristic value is the copper resistance of the coil S and is determined during the first holding interval T2, T2′. When using the second measuring current profile MS2, the temperature-dependent compensation parameter is the rate of rise of the coil current and is determined during the rise interval T5, T5′ of the second measuring current profile MS2. The rate of rise of the coil current from the measuring current profile MS2 also depends on the position of the armature A in the coil S and the energizing voltage. The voltage dependence is to be compensated for in a known manner by measuring back the supply voltage via which the control unit 14 actuates the solenoid 13.

In step S4, a position characteristic value of the hydraulic valve 11 is determined by the control unit 14 on the basis of the recorded current profile. If both the first and the second measuring current profiles MS1, MS2 are used, the position characteristic value is a temperature-and inductance-dependent position characteristic value, namely the current decay rate of the coil current, and is determined during the decay interval T3, T3′ of the first measuring current profile MS1 or during the decay interval T6, T6′ of the second measuring current profile MS2.

In step S5, the control unit 14 calculates the current switching position of the hydraulic valve 11 on the basis of the compensation characteristic value and the position characteristic value. The temperature dependence of the current decrease rate of the coil current (position characteristic value) is calculated using the determined copper resistance of the coil or the determined current increase rate of the coil current (compensation characteristic values), whereby a precise calculation of the current switching position of the hydraulic valve 11 is possible. The coil S and the armature A of the solenoid 13 of the hydraulic valve 11 are therefore used in parallel both to actuate the valve element 12 and to determine the switching position of the hydraulic valve 11 on the basis of the recorded current profile.

This allows the control unit 14 in optional step S6 to control the switching position of the hydraulic valve 11 or the flow rate flowing via the hydraulic valve 11 on the basis of the determined switching position.

Thus, a switching position and volume flow control for the hydraulic valve 11 is realized, which does not require the use of dedicated position sensors and at the same time is also suitable for directly controlled hydraulic valves with a single solenoid for actuating the hydraulic valve.

1. A method for determining a switching position of a directly controlled hydraulic valve, the hydraulic valve comprising a valve element and a solenoid with an armature and a coil, the armature being coupled to the valve element for joint movement between different switching positions, the method being carried out by a control unit associated with the hydraulic valve and comprising:
impressing a coil current in the coil of the solenoid, wherein the coil current is composed of an actuating current and a measuring current profile superimposed on the actuating current;
recording of the impressed coil current over time as a current profile;
determining a compensation characteristic value of the hydraulic valve on a basis of the current profile;
determining a position characteristic value of the hydraulic valve based on the current profile; and
calculating the switching position of the hydraulic valve on a basis of the compensation characteristic value and the position characteristic value.

2. The method according to claim 1, wherein the measuring current profile has a maximum measuring amplitude that depends on the current actuating current.

3. The method according to claim 1, wherein the measuring current profile has a maximum measuring amplitude that corresponds to a dither amplitude.

4. The method according to claim 1, wherein the compensation characteristic value of the hydraulic valve is a temperature-dependent compensation characteristic value of the solenoid.

5. The method according to claim 1, wherein the position characteristic value of the hydraulic valve is a temperature and inductance-dependent position characteristic value of the solenoid.

6. A method for controlling a directly controlled hydraulic valve, the hydraulic valve comprising a valve element and a solenoid with an armature and a coil, the armature being coupled to the valve element for joint movement between different switching positions, the method being carried out by a control unit associated with the hydraulic valve and comprising:
impressing a coil current in the coil of the solenoid, wherein the coil current is composed of an actuating current and a measuring current profile superimposed on the actuating current;
recording of the impressed coil current over time as a current profile;
determining a compensation characteristic value of the hydraulic valve on a basis of the current profile;
determining a position characteristic value of the hydraulic valve based on the current profile;
calculating a switching position of the hydraulic valve on a basis of the compensation characteristic value and the position characteristic value; and
controlling the switching position of the hydraulic valve based on the determined switching position.

7. A hydraulic valve with a valve element and a solenoid with an armature and a coil, wherein the armature is coupled to the valve element for joint movement between different switching positions, the hydraulic valve further comprising an integrated control unit configured to perform the method according to claim 1.

8. A hydraulic system with a hydraulic valve, the hydraulic valve comprising a valve element and a solenoid with an armature and a coil, the armature being coupled to the valve element for joint movement between different switching positions, the hydraulic system further comprising a control unit associated with the hydraulic valve and configured to perform the method according to claim 1.

9. The hydraulic system according to claim 8, wherein the control unit is integrated into the hydraulic valve.
